(19) United States
(12) Patent Application Publication
(10) Pub. No.: US 2017/0168222 A1
(43) Pub. Date: Jun. 15, 2017

(54) Backlight Module and Liquid Crystal Display Device

(71) Applicant: Shenzhen China Star Optoelectronics Technology Co., Ltd., Shenzhen, Guangdong (CN)

(72) Inventors: Shih-hsiang CHEN, Shenzhen, Guangdong (CN); Chengwen QUE, Shenzhen, Guangdong (CN); Dehua LI, Shenzhen, Guangdong (CN)

(73) Assignee: Shenzhen China Star Optoelectronics Technology Co., Ltd., Shenzhen, Guangdong (CN)

(21) Appl. No.: 14/890,448

(22) PCT Filed: Jul. 23, 2015
(86) PCT No.: PCT/CN2015/084864

§ 371 Date: Nov. 11, 2015

(30) Foreign Application Priority Data
Jun. 8, 2015 (CN) 201510310643.0

(51) Int. Cl. F21V 8/00

(52) U.S. Cl. CPC G02B 6/0046; G02B 6/0076; G02B 6/0085; G02B 6/0055; G02B 6/0068

(57) ABSTRACT

The disclosure is related to a backlight module and a liquid crystal display device. The backlight module comprises a first light guiding plate, a second light guiding plate and a light source. Wherein, the second light guiding plate is disposed below the first light guiding plate. The second illuminating surface of the second light guiding plate is adjacent and connected with the first bottom surface of the first light guiding plate. The second bottom surface inclines toward the second illuminating surface along the direction away from the second incident surface. The light source is configured for providing an incident light, the incident light passes through the first light guiding plate and the second light guiding plate and then illuminates from the first illuminating surface. The disclosure can lower the cost of the components of the product by the above methods.

### TECHNICAL FIELD

The disclosure is related to the field of liquid crystal display devices, and more particularly, to a backlight module and a liquid crystal display device.

### RELATED ART

In general, liquid crystal display devices comprise a front frame, a liquid crystal display screen, a backlight module and several driving circuit boards. Common backlight modules can be categorized into direct type and lateral type, wherein the thickness of the lateral type backlight modules is thinner than the direct type backlight modules, such that it is more favorable for thinning the liquid crystal display devices.

Currently, lateral type backlight modules mainly comprise a back shell, a reflective sheet, a light guiding plate, several optical films, a heat dissipating frame and a LED light bar (LB). In general, only one column of LED light beads is disposed on one LD, and is disposed at an end surface of the light guiding plate, such that the emitted light can be transported into the light guiding plate for mixing light. However, since the amount of LEDs disposed on the end surface of the light guiding plate is limited, and it needs more LEDs when the size of the liquid crystal display devices is larger, such that double lateral design or multiple lateral design will be used for liquid crystal display devices having a large size so as to increase the amount of disposed LEDs. Specifically, LB is disposed on the two lateral surfaces or multiple lateral surfaces of the light guiding plate for increasing the amount of disposed LED so as to satisfy the luminous flux of the liquid crystal display devices having a large size.

However, the increase of the LED light bars (LB) would cause the increase of the LED heat dissipating frames correspondingly, such that the cost of heat dissipation will be increased and is unfavorable for the designs of products.

### SUMMARY

The disclosure seeks to solve the technical problem of providing a backlight module and a liquid crystal display device, so as to lower the cost of the components of the products while ensuring the luminous flux of the liquid crystal display device.

In order to solve the above technical problem, the disclosure provides a technical solution: providing a backlight module, comprising: a first light guiding plate, having a first incident surface, a first bottom surface and a first illuminating surface, the first illuminating surface being parallel to the first bottom surface, and the first incident surface being connected with the first illuminating surface and the first bottom surface; a second light guiding plate, disposed below the first light guiding plate, the second light guiding plate having a second incident surface, a second illuminating surface and a second bottom surface, the second incident surface being connected with the second illuminating surface and the second bottom surface, the second incident surface leveling with the first incident surface along the vertical direction, the second illuminating surface being adjacent and connected with the first bottom surface, and the second bottom surface inclining toward the second illuminating surface along the direction away from the second incident surface; a light source, configured for providing an incident light, the incident light passing through the first incident surface of the first light guiding plate and the second incident surface of the second light guiding plate and then illuminating from the first illuminating surface; a heat dissipating frame, disposed outside the light source, the heat dissipating frame being configured for dissipating the heat generated by the light source; wherein, the light source comprises a first light bar disposed corresponding to the first incident surface and a second light bar disposed corresponding to the second incident surface;

the angle that the second bottom surface inclines toward the second illuminating surface satisfies the following equation:

$$A ≦ \frac{90 - arcsin ( \frac{sin B}{n} )}{2} ,$$

wherein, A is the angle that the second bottom surface inclines toward the second illuminating surface, B is the half angle of the illuminating angle of the light source, and n is the index of refraction of the second light guiding plate.

Wherein the backlight module further comprises: a heat dissipating frame, disposed outside the light source, the heat dissipating frame being configured for dissipating the heat generated by the light source.

In order to solve the above technical problem, the disclosure provides another technical solution: providing a backlight module, comprising: a first light guiding plate, having a first incident surface, a first bottom surface and a first illuminating surface, the first illuminating surface being parallel to the first bottom surface, and the first incident surface being connected with the first illuminating surface and the first bottom surface; a second light guiding plate, disposed below the first light guiding plate, the second light guiding plate having a second incident surface, a second illuminating surface and a second bottom surface, the second incident surface being connected with the second illuminating surface and the second bottom surface, the second incident surface leveling with the first incident surface along the vertical direction, the second illuminating surface being adjacent and connected with the first bottom surface, and the second bottom surface inclining toward the second illuminating surface along the direction away from the second incident surface; a light source, configured for providing an incident light, the incident light passing through the first incident surface of the first light guiding plate and the second incident surface of the second light guiding plate and then illuminating from the first illuminating surface; a heat dissipating frame, disposed outside the light source, the heat dissipating frame being configured for dissipating the heat generated by the light source.

Wherein, the light source comprises a first light bar disposed corresponding to the first incident surface and a second light bar disposed corresponding to the second incident surface.

The angle that the second bottom surface inclines toward the second illuminating surface satisfies the following equation:

$$A ≦ \frac{90 - arcsin ( \frac{sin B}{n} )}{2} ,$$

wherein, A is the angle that the second bottom surface inclines toward the second illuminating surface, B is the half angle of the illuminating angle of the light source, and n is the index of refraction of the second light guiding plate.

Wherein the second bottom surface connects with the second illuminating surface along the direction away from the second incident surface.

Wherein the second light guiding plate further comprises a connecting surface disposed opposite to the second incident surface, and the connecting surface connects with the second illuminating surface and the second bottom surface along the direction away from the second incident surface.

Wherein the width of the second illuminating surface is smaller than the width of the first bottom surface, and the width of the second illuminating surface is smaller than the width of the second bottom surface.

Wherein the backlight module further comprises a first reflective sheet and a second reflective sheet, the first reflective sheet is parallel to the first bottom surface and covers the section of the first bottom surface exposing the second light guiding plate, and the second reflective sheet is parallel to the second bottom surface and covers the second bottom surface.

Wherein the backlight module further comprises: a heat dissipating frame, disposed outside the light source, the heat dissipating frame being configured for dissipating the heat generated by the light source.

Wherein the second illuminating surface is bonded to the first bottom surface by a transparent colloid, and the transparent colloid comprises optical UV glue.

In order to solve the above technical problem, the disclosure provides another technical solution: providing a liquid crystal display device, comprising a backlight module, and the backlight module comprising: a first light guiding plate, having a first incident surface, a first bottom surface and a first illuminating surface, the first illuminating surface being parallel to the first bottom surface, and the first incident surface being connected with the first illuminating surface and the first bottom surface; a second light guiding plate, disposed below the first light guiding plate, the second light guiding plate having a second incident surface, a second illuminating surface and a second bottom surface, the second incident surface being connected with the second illuminating surface and the second bottom surface, the second incident surface leveling with the first incident surface along the vertical direction, the second illuminating surface being adjacent and connected with the first bottom surface, and l; a light source, configured for providing an incident light, the incident light passing through the first incident surface of the first light guiding plate and the second incident surface of the second light guiding plate and then illuminating from the first illuminating surface.

Wherein, the light source comprises a first light bar disposed corresponding to the first incident surface and a second light bar disposed corresponding to the second incident surface.

The angle that the second bottom surface inclines toward the second illuminating surface satisfies the following equation:

$$A ≦ \frac{90 - arcsin ( \frac{sin B}{n} )}{2} ,$$

wherein, A is the angle that the second bottom surface inclines toward the second illuminating surface, B is the half angle of the illuminating angle of the light source, and n is the index of refraction of the second light guiding plate.

Wherein the second bottom surface connects with the second illuminating surface along the direction away from the second incident surface.

Wherein the second light guiding plate further comprises a connecting surface disposed opposite to the second incident surface, and the connecting surface connects with the second illuminating surface and the second bottom surface along the direction away from the second incident surface.

Wherein the width of the second illuminating surface is smaller than the width of the first bottom surface, and the width of the second illuminating surface is smaller than the width of the second bottom surface.

Wherein the backlight module further comprises a first reflective sheet and a second reflective sheet, the first reflective sheet is parallel to the first bottom surface and covers the section of the first bottom surface exposing the second light guiding plate, and the second reflective sheet is parallel to the second bottom surface and covers the second bottom surface.

Wherein the backlight module further comprises: a heat dissipating frame, disposed outside the light source, the heat dissipating frame being configured for dissipating the heat generated by the light source.

Wherein the second illuminating surface is bonded to the first bottom surface by a transparent colloid, and the transparent colloid comprises optical UV glue.

Advantages of the disclosure: as compared with present technology, the backlight of the disclosure comprises a first light guiding plate and a second light guiding plate disposed below the first light guiding plate, wherein the first incident surface of the first light guiding plate levels with the second incident surface of the second light guiding plate along the vertical direction, and they both receive the incident light emitted from the light source. Further, the second bottom surface of the second light guiding plate inclines toward the second illuminating surface along the direction away from the second incident surface, such that the incident light received by the second incident surface of the second light guiding plate is guided toward the first light guiding plate, and the incident light is then emitted from the first light guiding plate. Thereby, the disclosure disposes two incident surfaces at the side of the incident light, such that LB only has to be disposed at the two incident surfaces and the luminous flux of the liquid crystal display devices with a large size can be achieved. Therefore, the heat dissipating frame only needs to be disposed at the two incident surfaces for dissipating heat, and the cost of the components of products is lowered.

### BRIEF DESCRIPTION OF THE DRAWINGS

In order to more clearly illustrate the embodiments of the disclosure, the accompanying drawings for illustrating the technical solutions and the technical solutions of the disclosure are briefly described as below.

FIG. 1 is a schematic view of a liquid crystal display device according to an embodiment of the disclosure;

FIG. 2 is a schematic view of the second light guiding plate in the backlight module in FIG. 1;

FIG. 3 is another schematic view of the second light guiding plate in the backlight module in FIG. 1; and

FIG. 4 is a schematic view of the light source in the backlight module in FIG. 1.

### DETAILED DESCRIPTION

The following description with reference to the accompanying drawings is provided to clearly and completely explain the exemplary embodiments of the disclosure. It is apparent that the following embodiments are merely some embodiments of the disclosure rather than all embodiments of the disclosure. According to the embodiments in the disclosure, all the other embodiments attainable by those skilled in the art without creative endeavor belong to the protection scope of the disclosure.

Referring to FIG. 1, which a schematic view of a liquid crystal display device according to an embodiment of the disclosure. As shown in FIG. 1, the liquid crystal display device 10 of the embodiment of the disclosure comprises a backlight module 100, a liquid crystal panel 200, a front frame 300, a back frame 400 and a middle frame 500. The front frame 300 matches with the back frame 400, and they form an accommodating space for accommodating the backlight module 100, the liquid crystal panel 200 and the middle frame 500. Wherein, the backlight module 100 is disposed at the back frame 400, the middle frame 500 presses the backlight module 100, and the middle frame 500 supports the liquid crystal panel 200, such that the liquid crystal panel 200 is disposed at the illuminating direction of the backlight module 100.

The backlight module 100 comprises a first light guiding plate 11, a second light guiding plate 12, a light source 13 and a heat dissipating frame 14. The first light guiding plate 11 has a first incident surface 110, a first bottom surface 111 and a first illuminating surface 112. The first illuminating surface 112 is parallel to the first bottom surface 111, and the first incident surface 112 is connected with the first illuminating surface 112 and the first bottom surface 111. In this embodiment, the first light guiding plate 11 is preferably a rectangular structure, and the first incident surface 110 is perpendicular to both the first illuminating surface 112 and the first bottom surface 111.

The second light guiding plate 12 is disposed below the first light guiding plate 11. The second light guiding plate 12 has a second incident surface 120, a second illuminating surface 121 and a second bottom surface 122. The second incident surface 120 is connected with the second illuminating surface 121 and the second bottom surface 122. The second incident surface 120 levels with the first incident surface 110 along the vertical direction. The second illuminating surface 121 is adjacent and connected with the first bottom surface 111, and the second bottom surface 122 inclines toward the second illuminating surface 121 along the direction away from the second incident surface 120, such that the second light guiding plate 12 is a wedge structure.

The light source 13 is configured for providing an incident light. The incident light passes through the first incident surface 110 of the first light guiding plate 11 and the second incident surface 120 of the second light guiding plate 12 and then illuminates from the first illuminating surface 112. In this embodiment, the light source 13 can be a LED light source.

The heat dissipating frame 14 is disposed outside the light source 13. The heat dissipating frame 14 is configured for dissipating the heat generated by the light source 13.

Thus, according to the embodiment, since the first light guiding plate 11 and the second light guiding plate 12 are disposed for receiving the incident light, the disclosure can satisfy the requirement of the luminous flux of liquid crystal display devices having a large size. Further, according to the embodiments of the disclosure, the light source 13 is only disposed at one side of the first incident surface 110 and the second incident surface 120, such that the heat dissipating frame 14 only has to be disposed at one side of the first incident surface 110 and the second incident surface 120. As compared with present technology that heat dissipating frames are disposed at two or more sides of the light guiding plate, the embodiments of the disclosure lower the cost of the components of products and optimizes the incident structure of the backlight module 100.

Further, since the light guiding plates of the liquid crystal display device 10 are generally plates with uniform thickness, such that the width of the incident surface is identical with the thickness of the plate. Thus, thicker plates are needed for increasing the thickness of the incident surface of the light guiding plate, such that the whole width of the liquid crystal display device 10 is increased, which is unfavorable for the thinning design. In the embodiments of the disclosure, a double layer of light guiding plate including the first light guiding plate 11 and the second light guiding plate 12 is disposed at the incident section of the light source 13. Wherein, the first light guiding plate 11 has a large size and is used as the main component for guiding light. Thus, in the embodiments of the disclosure, the luminous flux of the liquid crystal display device 10 can be further obtained without increasing the whole thickness of the liquid crystal display device 10.

In this embodiment, the second illuminating surface 121 is parallel to the first bottom surface 111, and the second illuminating surface 121 is bonded to the first bottom surface 111 by a transparent colloid. The transparent colloid comprises optical UV glue. The width of the second illuminating surface 121 is smaller than the width of the first bottom surface 111. For the convenience of processing, the width of the second illuminating surface 121 is preferably greater than or equal to two times of the width of the second light guiding plate 12.

Further, the width of the second illuminating surface 121 is smaller is smaller than the width of the second bottom surface 122. Specifically, the structure of the second light guiding plate 12 comprises the two following structures:

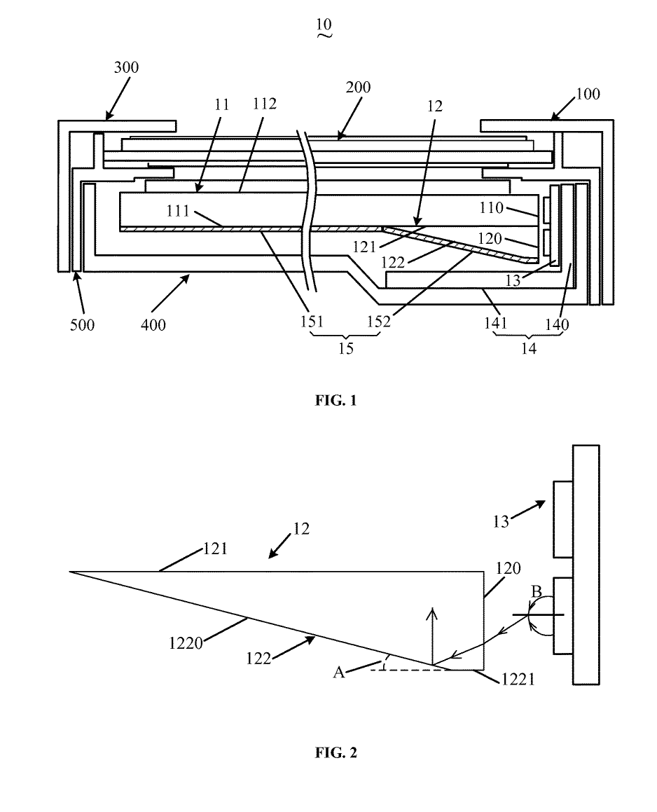

The first structure: referring to FIG. 2, which is a schematic view of the first structure of the second light guiding plate 12. As shown in FIG. 2, the second incident surface 120 of the second light guiding plate is perpendicular to the second illuminating surface 121 of the second light guiding plate. The second bottom surface 122 connects with the second illuminating surface 121 along the direction away from the second incident surface 120. Specifically, the second bottom surface 122 further comprises an inclined portion 1220 and a flat portion 1221 connected with each other. Wherein, one end of the flat portion 1221, which is away from the inclined portion 1220, is perpendicular and connected to the second incident surface 120. The inclined portion 1220 inclines toward the second illuminating surface 121 along the direction away from the flat portion 1221, and one end of the inclined portion 1220, which is away from the flat portion 1221, is connected with the second illuminating surface 121. Wherein, the inclined angle of the inclined portion 1220 satisfies the following equation:

$$A ≦ \frac{90 - arcsin ( \frac{sin B}{n} )}{2} ,$$

wherein, A is the angle that the inclined portion 1220 of the second bottom surface 122 inclines toward the second illuminating surface 121, B is the half angle of the illuminating angle of the light source 13, and n is the index of refraction of the second light guiding plate 12.

In this embodiment, since the flat portion 1221 is disposed, it is more convenient for clamping when manufacturing the second light guiding plate 12 so as to ensure the accuracy of the shape of the inclined surface of the inclined portion 1220 of the second light guiding plate 12.

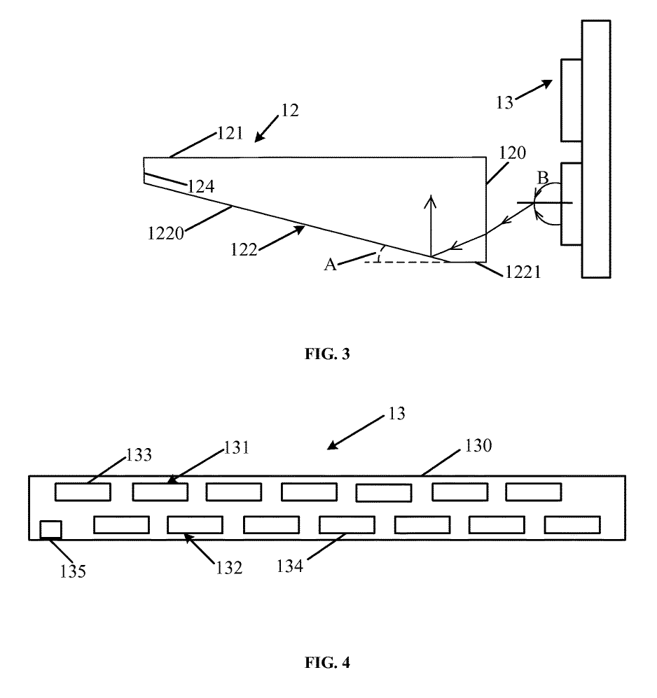

The second structure: referring to FIG. 3, which is a schematic view of the second structure of the second light guiding plate 12. As shown in FIG. 3, besides the second incident surface 120, the second illuminating surface 121 and the second bottom surface 122, the second light guiding plate 12 further comprises a connecting surface 124 disposed opposite to the second incident surface 120. Preferably, in the embodiment, the connecting surface 124 is parallel to the second incident surface 120, and the length of the connecting surface 124 is shorter than the length of the second incident surface 120. The connecting surface 124 connects with the second illuminating surface 121 and the second bottom surface 122 along the direction away from the second incident surface 120. Specifically, the connecting surface 124 connects with the inclined portion 1220 of the second bottom surface 122. Wherein, the structures of the second incident surface 120, the second illuminating surface 121 and the second bottom surface 122 in FIG. 3 are identical with the ones in FIG. 2, so they are not described again.

As shown in FIG. 3, the second light guiding plate 12 further comprises the connecting surface 124 and forms a trapezoid structure, such that an acute structure at the connected portion between the inclined portion 1220 of the second light guiding plate 12 and the second illuminating surface 121 of the second light guiding plate 12 can be avoided, and the strength of the second light guiding plate 12 can be strengthened.

Referring to FIG. 1 again, in this embodiment, the backlight module 100 further comprises a reflective sheet 15. The reflective sheet 15 covers the second bottom surface 122 and the section of the first bottom surface 111 exposing the second light guiding plate 12. Specifically, the reflective sheet 15 comprises a first reflective sheet 151 and a second reflective sheet 152. The first reflective sheet 151 is parallel to the first bottom surface 111 and covers the section of the first bottom surface 111 exposing the second light guiding plate 12, and the second reflective sheet 152 is parallel to the second bottom surface 122 and covers the second bottom surface 122.

For ensuring the luminous flux entering the first light guiding plate 11 and the second light guiding plate 12, in this embodiment of the disclosure, light bars are disposed corresponding to the first light guiding plate 11 and the second light guiding plate 12 respectively. Referring to FIG. 4, which is a schematic view of the light source 13 of the embodiment of the disclosure. As shown in FIG. 4, the light source 13 comprises a PCB board 130, a first light bar 131 and a second light bar 132. The first light bar 131 and the second light bar 132 are disposed on the PCB board 130. The first light bar 131 is disposed corresponding to the first incident surface 110, and the second light bar 132 is disposed corresponding to the second incident surface 120. Wherein, the first light bar 131 is parallel to the second light bar 132. The first light bar 131 comprises a plurality of LED lamp beads 133, and the second light bar 132 comprises a plurality of LED lamp beads 134. Each of the LED lamp beads 134 is disposed between two adjacent LED lamp beads 133, such that the LED lamp beads 133 and the LED lamp beads 134 are disposed alternatively. Thereby, the incident light of the light source 13 is more uniform.

Referring to FIG. 1 again, the heat dissipating frame 14 is L-shaped. Specifically, the heat dissipating frame 14 comprises a first section 140 and a second section 141 perpendicular to each other. Wherein part of the first section 140 attaches to one side of the light source 133, where light bars are not disposed, and the second section 141 is disposed on the back frame, such that the heat received by the first section 140 can be conducted to the second section 141 for dissipating the heat. Wherein, the heat dissipating frame 14 is generally made of materials having great thermal conductivity, such as Al and so forth.

In other embodiments, the heat dissipating frame 14 can be [symbol] -shaped.

According to the above description, the liquid crystal panel of the embodiments of the disclosure can lower the cost of the components of the products and optimizes the incident structure of the backlight module.

Note that the specifications relating to the above embodiments should be construed as exemplary rather than as limitative of the present disclosure. The equivalent variations and modifications on the structures or the process by reference to the specification and the drawings of the disclosure, or application to the other relevant technology fields directly or indirectly should be construed similarly as falling within the protection scope of the disclosure.

What is claimed is:

1. A backlight module, comprising:
a first light guiding plate, having a first incident surface, a first bottom surface and a first illuminating surface, the first illuminating surface being parallel to the first bottom surface, and the first incident surface being connected with the first illuminating surface and the first bottom surface;
a second light guiding plate, disposed below the first light guiding plate, the second light guiding plate having a second incident surface, a second illuminating surface and a second bottom surface, the second incident surface being connected with the second illuminating surface and the second bottom surface, the second incident surface leveling with the first incident surface along the vertical direction, the second illuminating surface being adjacent and connected with the first bottom surface, and the second bottom surface inclining toward the second illuminating surface along the direction away from the second incident surface; and
a light source, configured for providing an incident light, the incident light passing through the first incident surface of the first light guiding plate and the second incident surface of the second light guiding plate and then illuminating from the first illuminating surface;
wherein, the light source comprises a first light bar disposed corresponding to the first incident surface and a second light bar disposed corresponding to the second incident surface;
the angle that the second bottom surface inclines toward the second illuminating surface satisfies the following equation:
$$A ≦ \frac{90 - arcsin ( \frac{sin B}{n} )}{2} ,$$
wherein, A is the angle that the second bottom surface inclines toward the second illuminating surface, B is the half angle of the illuminating angle of the light source, and n is the index of refraction of the second light guiding plate.

2. The backlight module according to claim 1, wherein the backlight module further comprises:
a heat dissipating frame, disposed outside the light source, the heat dissipating frame being configured for dissipating the heat generated by the light source.

3. A backlight module, comprising:
a first light guiding plate, having a first incident surface, a first bottom surface and a first illuminating surface, the first illuminating surface being parallel to the first bottom surface, and the first incident surface being connected with the first illuminating surface and the first bottom surface;
a second light guiding plate, disposed below the first light guiding plate, the second light guiding plate having a second incident surface, a second illuminating surface and a second bottom surface, the second incident surface being connected with the second illuminating surface and the second bottom surface, the second incident surface leveling with the first incident surface along the vertical direction, the second illuminating surface being adjacent and connected with the first bottom surface, and the second bottom surface inclining toward the second illuminating surface along the direction away from the second incident surface; and
a light source, configured for providing an incident light, the incident light passing through the first incident surface of the first light guiding plate and the second incident surface of the second light guiding plate and then illuminating from the first illuminating surface.

4. The backlight module according to claim 3, wherein the light source further comprises a first light bar disposed corresponding to the first incident surface and a second light bar disposed corresponding to the second incident surface.

5. The backlight module according to claim 3, wherein the angle that the second bottom surface inclines toward the second illuminating surface satisfies the following equation:
$$A ≦ \frac{90 - arcsin ( \frac{sin B}{n} )}{2} ,$$
wherein, A is the angle that the second bottom surface inclines toward the second illuminating surface, B is the half angle of the illuminating angle of the light source, and n is the index of refraction of the second light guiding plate.

6. The backlight module according to claim 3, wherein the second bottom surface connects with the second illuminating surface along the direction away from the second incident surface.

7. The backlight module according to claim 3, wherein the second light guiding plate further comprises a connecting surface disposed opposite to the second incident surface, and the connecting surface connects with the second illuminating surface and the second bottom surface along the direction away from the second incident surface.

8. The backlight module according to claim 3, wherein the width of the second illuminating surface is smaller than the width of the first bottom surface, and the width of the second illuminating surface is smaller than the width of the second bottom surface.

9. The backlight module according to claim 8, wherein the backlight module further comprises a first reflective sheet and a second reflective sheet, the first reflective sheet is parallel to the first bottom surface and covers the section of the first bottom surface exposing the second light guiding plate, and the second reflective sheet is parallel to the second bottom surface and covers the second bottom surface.

10. The backlight module according to claim 3, wherein the backlight module further comprises:
a heat dissipating frame, disposed outside the light source, the heat dissipating frame being configured for dissipating the heat generated by the light source.

11. The backlight module according to claim 3, wherein the second illuminating surface is bonded to the first bottom surface by a transparent colloid, and the transparent colloid comprises optical UV glue.

12. A liquid crystal display device, comprising:
a backlight module, comprising:
a first light guiding plate, having a first incident surface, a first bottom surface and a first illuminating surface, the first illuminating surface being parallel to the first bottom surface, and the first incident surface being connected with the first illuminating surface and the first bottom surface;
a second light guiding plate, disposed below the first light guiding plate, the second light guiding plate having a second incident surface, a second illuminating surface and a second bottom surface, the second incident surface being connected with the second illuminating surface and the second bottom surface, the second incident surface leveling with the first incident surface along the vertical direction, the second illuminating surface being adjacent and connected with the first bottom surface, and the second bottom surface inclining toward the second illuminating surface along the direction away from the second incident surface; and
a light source, configured for providing an incident light, the incident light passing through the first incident surface of the first light guiding plate and the second incident surface of the second light guiding plate and then illuminating from the first illuminating surface.

13. The liquid crystal display device according to claim 12, wherein the light source further comprises a first light bar disposed corresponding to the first incident surface and a second light bar disposed corresponding to the second incident surface.

14. The liquid crystal display device according to claim 12, wherein the angle that the second bottom surface inclines toward the second illuminating surface satisfies the following equation:
$$A ≦ \frac{90 - arcsin ( \frac{sin B}{n} )}{2} ,$$
wherein, A is the angle that the second bottom surface inclines toward the second illuminating surface, B is the half angle of the illuminating angle of the light source, and n is the index of refraction of the second light guiding plate.

15. The liquid crystal display device according to claim 12, wherein the second bottom surface connects with the second illuminating surface along the direction away from the second incident surface.

16. The liquid crystal display device according to claim 12, wherein the second light guiding plate further comprises a connecting surface disposed opposite to the second incident surface, and the connecting surface connects with the second illuminating surface and the second bottom surface along the direction away from the second incident surface.

17. The liquid crystal display device according to claim 12, wherein the width of the second illuminating surface is smaller than the width of the first bottom surface, and the width of the second illuminating surface is smaller than the width of the second bottom surface.

18. The liquid crystal display device according to claim 17, wherein the backlight module further comprises a first reflective sheet and a second reflective sheet, the first reflective sheet is parallel to the first bottom surface and covers the section of the first bottom surface exposing the second light guiding plate, and the second reflective sheet is parallel to the second bottom surface and covers the second bottom surface.

19. The liquid crystal display device according to claim 12, wherein the backlight module further comprises:
a heat dissipating frame, disposed outside the light source, the heat dissipating frame being configured for dissipating the heat generated by the light source.

20. The liquid crystal display device according to claim 12, wherein the second illuminating surface is bonded to the first bottom surface by a transparent colloid, and the transparent colloid comprises optical UV glue.
